(19) United States
(12) Patent Application Publication
(10) Pub. No.: US 2014/0082931 A1
(43) Pub. Date: Mar. 27, 2014

(54) METHOD FOR PRODUCING ALL SOLID STATE BATTERY

(71) Applicants: Junichiro Nishino, Gotenba-shi (JP); Keigo Yamada, Susono-shi (JP); Hideaki Miyake, Susono-shi (JP); Syuuhei Sugiyama, Numazu-shi (JP)

(72) Inventors: Junichiro Nishino, Gotenba-shi (JP); Keigo Yamada, Susono-shi (JP); Hideaki Miyake, Susono-shi (JP); Syuuhei Sugiyama, Numazu-shi (JP)

(73) Assignee: TOYOTA JIDOSHA KABUSHIKI KAISHA, Toyota-shi, Aichi (JP)

(21) Appl. No.: 14/116,564

(22) PCT Filed: Jun. 2, 2011
(86) PCT No.: PCT/JP2011/062713

§ 371 Date: Nov. 8, 2013

(51) Int. Cl. H01M 10/04

(52) U.S. Cl. CPC H01M 10/04
USPC 29/623.4

(57) ABSTRACT

The problem of the present invention is to provide a method for producing an all solid state battery excellent in adhesion properties between electrode active material layers and a solid electrolyte layer. The present invention solves the above-mentioned problem by providing a method for producing an all solid state battery comprising a pressing step of isostatically pressing a body to be pressed, provided with a power generating element having a cathode active material layer, an anode active material layer, and a solid electrolyte layer formed between the above-mentioned cathode active material layer and the above-mentioned anode active material layer.

### TECHNICAL FIELD

The present invention relates to a method for producing an all solid state battery excellent in adhesion properties between electrode active material layers and a solid electrolyte layer.

### BACKGROUND ART

For example, a lithium secondary battery has been widely put to practical use in the field of information relevant apparatuses and communication apparatuses by reason of including a high electromotive force and a high energy density. On the other hand, the development of an electric automobile and a hybrid automobile has been hastened also in the field of automobiles from the viewpoint of environmental issues and resource problems, and a lithium secondary battery has been studied also as a power source thereof.

Liquid electrolyte containing a flammable organic solvent is used for a presently commercialized lithium secondary battery, so that the installation of a safety device for restraining temperature rise during a short circuit and the improvement in structure and material for preventing the short circuit are necessary therefor. On the contrary, an all solid lithium secondary battery all-solidified by replacing the liquid electrolyte with a solid electrolyte layer is conceived to intend the simplification of the safety device and be excellent in production cost and productivity for the reason that the flammable organic solvent is not used in the battery.

Conventionally, pressing by planar press and roll press has been known for improving adhesion properties between electrode active material layers (a cathode active material layer and an anode active material layer) and a solid electrolyte layer. On the other hand, in Patent Literatures 1 to 3, cold isostatic pressing (CIP) is disclosed as an example of a method for forming a solid electrolyte layer. Also, in Patent Literature 4, a battery, which is partitioned into plural regions and provided with an electrode substrate folded in each of the regions, is disclosed.

### CITATION LIST

### Patent Literature

Patent Literature 1: Japanese Patent Application Publication (JP-A) No. 2008-112661
Patent Literature 2: JP-A No. 2010-108809
Patent Literature 3: JP-A No. 2010-108802
Patent Literature 4: JP-A No. 2010-067443

### SUMMARY OF INVENTION

### Technical Problem

As described above, pressing is performed by planar press and roll press for improving adhesion properties between electrode active material layers and a solid electrolyte layer. However, minute irregularities on the surface of the electrode active material layers and the solid electrolyte layer make it difficult to uniformly press the surface and make it difficult to sufficiently improve adhesion properties between the electrode active material layers and the solid electrolyte layer.

The present invention has been made in view of the above-mentioned problem, and the main object thereof is to provide a method for producing an all solid state battery excellent in adhesion properties between electrode active material layers and a solid electrolyte layer.

### Solution to Problem

In order to achieve the above-mentioned object, the present invention provides a method for producing an all solid state battery comprising a pressing step of isostatically pressing a body to be pressed, provided with a power generating element having a cathode active material layer, an anode active material layer, and a solid electrolyte layer formed between the above-mentioned cathode active material layer and the above-mentioned anode active material layer.

According to the present invention, an all solid state battery excellent in adhesion properties between electrode active material layers and a solid electrolyte layer may be obtained by isostatically pressing a power generating element.

In the above-mentioned invention, the above-mentioned isostatic pressing is preferably pressing by hydraulic pressure. The reason therefor is to allow a power generating element to be pressed more effectively.

In the above-mentioned invention, the above-mentioned body to be pressed is preferably such that a battery element having the above-mentioned power generating element, and a cathode current collector and an anode current collector for collecting the above-mentioned power generating element is sealed with an exterior body. The reason therefor is that the isostatic pressing after sealing the battery element with the exterior body allows electrode active material layers to be effectively prevented from cracking and peeling off.

In the above-mentioned invention, the pressure of the above-mentioned isostatic pressing is preferably within a range of 200 MPa to 1000 MPa.

In the above-mentioned invention, the above-mentioned body to be pressed preferably has an elastic body. The reason therefor is that the use of the elastic body allows the body to be pressed to be prevented from minutely deforming and a warp to be prevented from occurring.

In the above-mentioned invention, it is preferable that the above-mentioned body to be pressed is such that the above-mentioned exterior body sealing the above-mentioned battery element is further sealed with a protector, and the pressure between the above-mentioned exterior body and the above-mentioned protector is made higher than the pressure inside the above-mentioned exterior body. The reason therefor is to allow a power generating element to be pressed more effectively.

In the above-mentioned invention, it is preferable that the above-mentioned body to be pressed has a battery element having the above-mentioned power generating element, and a cathode current collector and an anode current collector for collecting the above-mentioned power generating element, the above-mentioned battery element has a plurality of the above-mentioned power generating elements between the above-mentioned cathode current collector and the above-mentioned anode current collector, and has an insulating layer between the above-mentioned adjacent power generating elements, and the above-mentioned body to be pressed is bent in a position of the above-mentioned insulating layer. The reason therefor is that the body to be pressed may be disposed with a high density in an isostatic pressing device by bending.

### Advantageous Effects of Invention

The present invention produces the effect such as to allow an all solid state battery excellent in adhesion properties between electrode active material layers and a solid electrolyte layer to be obtained.

### BRIEF DESCRIPTION OF DRAWINGS

FIGS. 1A to 1D are schematic cross-sectional views showing an example of a method for producing an all solid state battery of the present invention.

FIGS. 2A and 2B are schematic cross-sectional views explaining the demerit of conventional pressing.

FIGS. 3A and 3B are schematic cross-sectional views explaining isostatic pressing in the present invention.

FIGS. 4A to 4C are schematic cross-sectional views exemplifying a battery element in the present invention.

FIG. 5 is a schematic cross-sectional view explaining a body to be pressed in the present invention.

FIG. 6 is a schematic cross-sectional view explaining a body to be pressed in the present invention.

FIGS. 7A to 7C are schematic perspective views showing an example of pressing step in the present invention.

FIGS. 8A and 8B are schematic views showing an example of a battery element in the present invention.

FIGS. 9A to 9D are schematic perspective views showing another example of pressing step in the present invention.

FIGS. 10A and 10B are schematic views explaining an all solid state battery obtained by the present invention.

FIG. 11 is a result of measuring discharge capacity and internal resistance in an all solid state battery obtained in examples and comparative examples.

### DESCRIPTION OF EMBODIMENTS

A method for producing an all solid state battery of the present invention is hereinafter described in detail.

A method for producing an all solid state battery of the present invention comprises a pressing step of isostatically pressing a body to be pressed, provided with a power generating element having a cathode active material layer, an anode active material layer, and a solid electrolyte layer formed between the above-mentioned cathode active material layer and the above-mentioned anode active material layer.

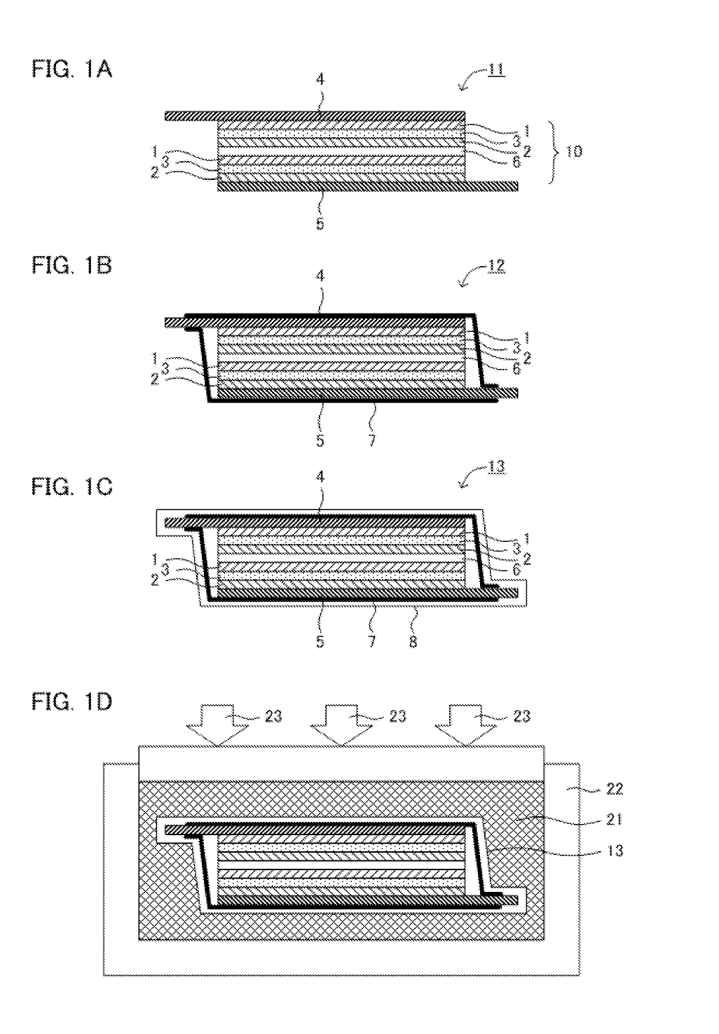

FIGS. 1A to 1D are schematic cross-sectional views showing an example of the method for producing an all solid state battery of the present invention. In FIGS. 1A to 1D, first, a battery element 11 having a power generating element 10 having a cathode active material layer 1, an anode active material layer 2, and a solid electrolyte layer 3 formed between the cathode active material layer 1 and the anode active material layer 2, and a cathode current collector 4 and an anode current collector 5 for collecting the power generating element 3 is prepared (FIG. 1A). This power generating element 10 is the so-called bipolar power generating element and has an interlayer current collector 6. Also, the cathode current collector 4 and the anode current collector 5 are formed on the surface of the cathode active material layer 1 and the anode active material layer 2 respectively, located in the outermost part of the power generating element 10.

Next, the battery element 11 is sealed with an exterior body 7 to obtain a battery element-containing exterior body 12 (FIG. 1B). Next, the battery element-containing exterior body 12 is further sealed with a protector 8 to obtain an exterior body-containing protector 13 (FIG. 1C). In FIGS. 1A to 1D, this exterior body-containing protector 13 becomes a body to be pressed. Incidentally, the protector 8 is, for example, a film having water resistance and insulation properties. Next, the exterior body-containing protector 13 is put in a pressure-resistant container (such as an iron container) 22 filled with a liquid (such as water) 21 to apply a pressure 23 thereto (FIG. 1D). Finally, an all solid state battery is obtained by peeling off the protector 8. Incidentally, the all solid state battery obtained by the present invention signifies a member having at least a power generating element.

According to the present invention, an all solid state battery excellent in adhesion properties between electrode active material layers and a solid electrolyte layer may be obtained by isostatically pressing a power generating element. Conventional planar press and roll press has the following problem. That is to say, there are minute irregularities (such as irregularities of several μm) on the surface of the electrode active material layers and the solid electrolyte layer, so that anisotropic pressing such as planar press and roll press easily causes pressure to become higher in a convex portion and pressure to become lower in a concave portion. As a result, the surface may not be uniformly pressed and it becomes difficult to sufficiently improve adhesion properties between the electrode active material layers and the solid electrolyte layer.

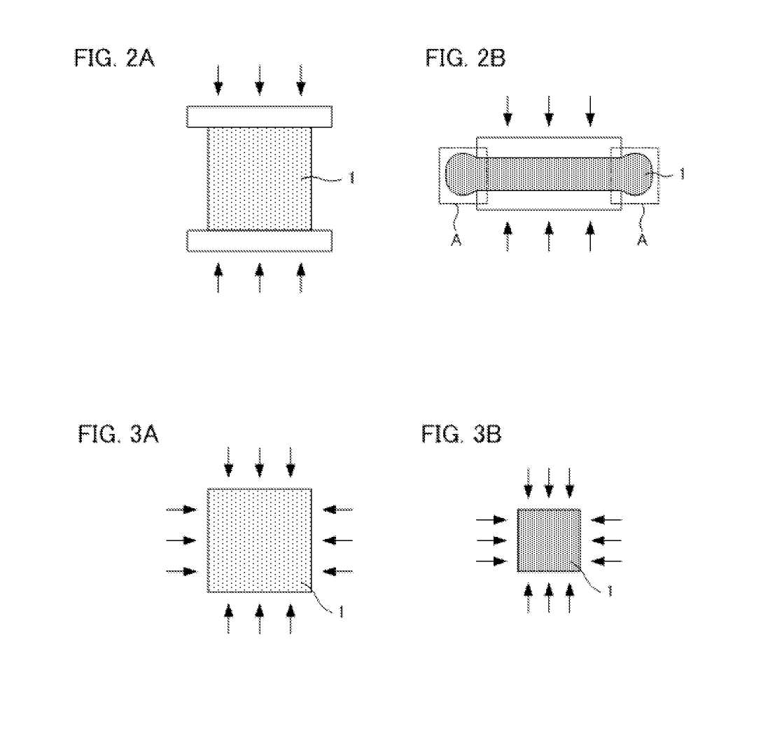

Also, it is conceived that pressure to be applied is made higher for realizing high adhesion properties; however, the electrode active material layers and the solid electrolyte layer have a property that the layers harden (embrittle) when filling factor increases by compression for the reason that the layers are such that powders such as active materials and a solid electrolyte material are firmly fixed. For example, there is a property that when the cathode active material layer 1 is pressed from an upward and downward direction as shown in FIG. 2A, a rolling deformation part A is caused in accordance with the increase of the filling factor by compression as shown in FIG. 2B, and the cathode active material layer 1 hardens (embrittles) in the rolling deformation part A. As a result, the problem is that the cracking of the electrode active material layers or the solid electrolyte layer, the peeling between the electrode active material layers and the solid electrolyte layer, and the peeling between the electrode active material layers and the current collectors are caused. In particular, the occurrence of the cracking in the solid electrolyte layer brings a possibility of causing a short circuit of the battery.

On the contrary, according to the present invention, such as shown in FIG. 3A, the cathode active material layer 1 may be pressed by uniform pressure from all directions while utilizing water pressure, so that the rolling deformation part as described above may be prevented from occurring as shown in FIG. 3B. Thus, even though pressure to be applied is determined higher, there is an advantage that the cracking of the electrode active material layers or the solid electrolyte layer, the peeling between the electrode active material layers and the solid electrolyte layer, and the peeling between the electrode active material layers and the current collectors are caused with difficulty. Also, the determination of pressure to be applied at a higher level allows the filling factor of each of the layers to be improved, and allows the all solid state battery favorable in battery performance (capacity and output) to be obtained.

On the other hand, in Patent Literatures 1 to 3, cold isostatic pressing (CIP) is disclosed as an example of a method for forming a solid electrolyte layer. However, these techniques target the same kind of solid electrolyte particles or the same kind of solid electrolyte sheets, and form the solid electrolyte layer out of these members; in Patent Literatures 1 to 3, adhesion properties between different kinds of layers, that is, the electrode active material layers and the solid electrolyte layer are not disclosed at all. On the contrary, in the present invention, isostatic pressing on the whole power generating element allows adhesion properties between the electrode active material layers and the solid electrolyte layer to be sufficiently improved. Incidentally, isostatic pressing on only the solid electrolyte layer causes the surface to harden and smooth, so that adhesion properties to the electrode active material layers having minute irregularities deteriorate.

The pressing step in the present invention is hereinafter described in further detail. The pressing step in the present invention is a step of isostatically pressing a body to be pressed, which is provided with a power generating element.

1. Body to be Pressed First, a body to be pressed in the present invention is described. The body to be pressed in the present invention is provided with at least a power generating element having a cathode active material layer, an anode active material layer, and a solid electrolyte layer formed between the cathode active material layer and the anode active material layer. Specific examples of the body to be pressed include (i) a power generating element, (ii) a battery element having the power generating element, a cathode current collector and an anode current collector, and (iii) a battery element-containing exterior body such that the battery element is sealed with an exterior body. Also, each of the members of (i) to (iii) may be sealed with a protector for protecting from a pressing medium of isostatic pressing.

(1) Power Generating Element

The power generating element in the present invention has a cathode active material layer, an anode active material layer, and a solid electrolyte layer formed between the cathode active material layer and the anode active material layer.

(i) Cathode Active Material Layer

The cathode active material layer in the present invention is a layer containing at least the cathode active material, and may further contain at least one of a solid electrolyte material, a conductive material and a binder as required. The cathode active material is not particularly limited and examples thereof include an oxide active material and a sulfide active material. Examples of the oxide active material used as the cathode active material of an all solid lithium battery include rock salt bed type active materials such as LiCoO₂, LiMnO₂, LiNiO₂, LiVO₂ and LiNi_{1/3}Co_{1/3}Mn_{1/3}O₂, spinel type active materials such as LiMn₂O₄ and Li(Ni_{0.5}Mn_{1.5})O₄, olivine type active materials such as LiFePO₄ and LiMnPO₄, and Si-containing active materials such as Li₂FeSiO₄ and Li₂MnSiO₄. A coat layer for inhibiting a reaction with a sulfide solid electrolyte material is preferably formed on the surface of the oxide active material. The reason therefor is to allow a high resistive layer to be inhibited from occurring by a reaction between the oxide active material and the sulfide solid electrolyte material. Examples of a material for the coat layer include an oxide material having ion conductivity, and specific examples thereof include lithium niobate. Also, examples of the sulfide active material used as the cathode active material of an all solid lithium battery include copper Chevrel, iron sulfide, cobalt sulfide and nickel sulfide.

Examples of the shape of the cathode active material include a particulate shape. The average particle diameter of the cathode active material (D₅₀) is, for example, preferably within a range of 0.1 μm to 50 μm. Incidentally, the average particle diameter may be measured by a granulometer. Also, the content of the cathode active material in the cathode active material layer is, for example, preferably within a range of 10% by weight to 99% by weight, and more preferably within a range of 20% by weight to 90% by weight.

The cathode active material layer preferably contains the solid electrolyte material further. The reason therefor is to allow ion conductivity in the cathode active material layer to be improved. Incidentally, the solid electrolyte material contained in the cathode active material layer is the same as the solid electrolyte material described in the after-mentioned ‘(iii) Solid electrolyte layer’. The content of the solid electrolyte material in the cathode active material layer is, for example, preferably within a range of 1% by weight to 90% by weight, and more preferably within a range of 10% by weight to 80% by weight.

The cathode active material layer may further contain a conductive material. The addition of the conductive material allows electron conductivity of the cathode active material layer to be improved. Examples of the conductive material include acetylene black, Ketjen Black and carbon fiber. Also, the cathode active material layer may further contain a binder. Examples of the binder include fluorine-containing binders such as PTFE and PVDF. Also, the thickness of the cathode active material layer varies with kinds of an intended battery, and is preferably within a range of 0.1 μm to 1000 μm, for example.

(ii) Anode Active Material Layer

The anode active material layer in the present invention is a layer containing at least the anode active material, and may further contain at least one of a solid electrolyte material, a conductive material and a binder as required. The anode active material is not particularly limited and examples thereof include a carbon active material, a metal active material and an oxide active material. Examples of the carbon active material include graphite such as mesocarbon microbeads (MCMB) and high orientation property graphite (HOPG), and amorphous carbon such as hard carbon and soft carbon. Examples of the metal active material include In, Al, Si, and Sn. Also, examples of the oxide active material include Nb₂O₅, Li₄Ti₅O₁₂ and SiO.

Examples of the shape of the anode active material include a particulate shape and a filmy shape. The average particle diameter of the anode active material (D₅₀) is, for example, preferably within a range of 0.1 μm to 50 μm. Incidentally, the average particle diameter may be measured by a granulometer. Also, the content of the anode active material in the anode active material layer is, for example, preferably within a range of 10% by weight to 99% by weight, and more preferably within a range of 20% by weight to 90% by weight.

The anode active material layer preferably contains the solid electrolyte material further. The reason therefor is to allow ion conductivity in the anode active material layer to be improved. Incidentally, the solid electrolyte material contained in the anode active material layer is the same as the solid electrolyte material described in the after-mentioned ‘(iii) Solid electrolyte layer’. The content of the solid electrolyte material in the anode active material layer is, for example, preferably within a range of 1% by weight to 90% by weight, and more preferably within a range of 10% by weight to 80% by weight.

The anode active material layer may further contain a conductive material. Also, the anode active material layer may further contain a binder. The conductive material and the binder are the same as the contents described in the above-mentioned ‘(i) Cathode active material layer’; therefore, the description herein is omitted. Also, the thickness of the anode active material layer varies with kinds of an intended battery, and is preferably within a range of 0.1 μm to 1000 μm, for example.

(iii) Solid Electrolyte Layer

The solid electrolyte layer in the present invention is a layer containing a solid electrolyte material. Examples of the solid electrolyte material include a sulfide solid electrolyte material and an oxide solid electrolyte material. The sulfide solid electrolyte material is preferable in view of being mostly high in ion conductivity as compared with the oxide solid electrolyte material, and the oxide solid electrolyte material is preferable in view of being high in chemical stability as compared with the sulfide solid electrolyte material.

Examples of the oxide solid electrolyte material used for an all solid lithium battery include a compound having a NASICON type structure. Examples of the compound having a NASICON type structure include a compound represented by a general formula Li₁₊ₓAlₓGe₂₋ₓ(PO₄)₃ (0≦x≦2). Above all, the above-mentioned compound is preferably Li_{1.5}Al_{0.5}Ge_{1.5}(PO₄)₃. Also, other examples of the compound having a NASICON type structure include a compound represented by a general formula Li₁₊ₓAlₓTi₂₋ₓ(PO₄)₃ (0≦x≦2). Above all, the above-mentioned compound is preferably Li_{1.5}Al_{0.5}Ti_{1.5}(PO₄)₃. Also, other examples of the oxide solid electrolyte material used for an all solid lithium secondary battery include LiLaTiO (such as Li_{0.34}La_{0.51}TiO₃). LiPON (such as Li_{2.9}PO_{3.3}N_{0.46}) and LiLaZrO (such as Li₇La₃Zr₂O₁₂)

Examples of the sulfide solid electrolyte material used for an all solid lithium battery include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (“m” and “n” are positive numbers; Z is any of Ge, Zn and Ga.), Li₂S—GeS₂, Li₂S—SiS₂—Li₃PO₄, and Li₂S—SiS₂—LiₓMO_{y} (“x” and “y” are positive numbers; M is any of P, Si, Ge, B, Al, Ga and In). Incidentally, the description of the above-mentioned “Li₂S—P₂S₅” signifies the sulfide solid electrolyte material obtained by using a raw material composition containing Li₂S and P₂S₅, and other descriptions signify similarly. Also, the sulfide solid electrolyte material may be sulfide glass or crystallized sulfide glass.

The content of the solid electrolyte material in the solid electrolyte layer is preferably, for example, 60% by weight or more, above all, 70% by weight or more, and particularly, 80% by weight or more. The solid electrolyte layer may contain a binder or consist of only the solid electrolyte material. The thickness of the solid electrolyte layer varies greatly with constitutions of a battery, and is preferably, for example, within a range of 0.1 μm to 1000 μm, and above all, within a range of 0.1 μm to 300 μm.

(iv) Power Generating Element

The power generating element in the present invention is not particularly limited if the power generating element is such as to have a cathode active material layer, an anode active material layer, and a solid electrolyte layer. Also, the power generating element may be a monopolar power generating element or a bipolar power generating element.

(2) Battery Element

The battery element in the present invention has a power generating element, and a cathode current collector and an anode current collector for collecting the above-mentioned power generating element. Examples of a material for the cathode current collector include SUS, aluminum, nickel, iron, titanium and carbon. Also, examples of a material for the anode current collector include SUS, copper, nickel and carbon. The thickness of the cathode current collector and the anode current collector is not particularly limited if the thickness is such as to allow isostatic pressure to be applied to the power generating element.

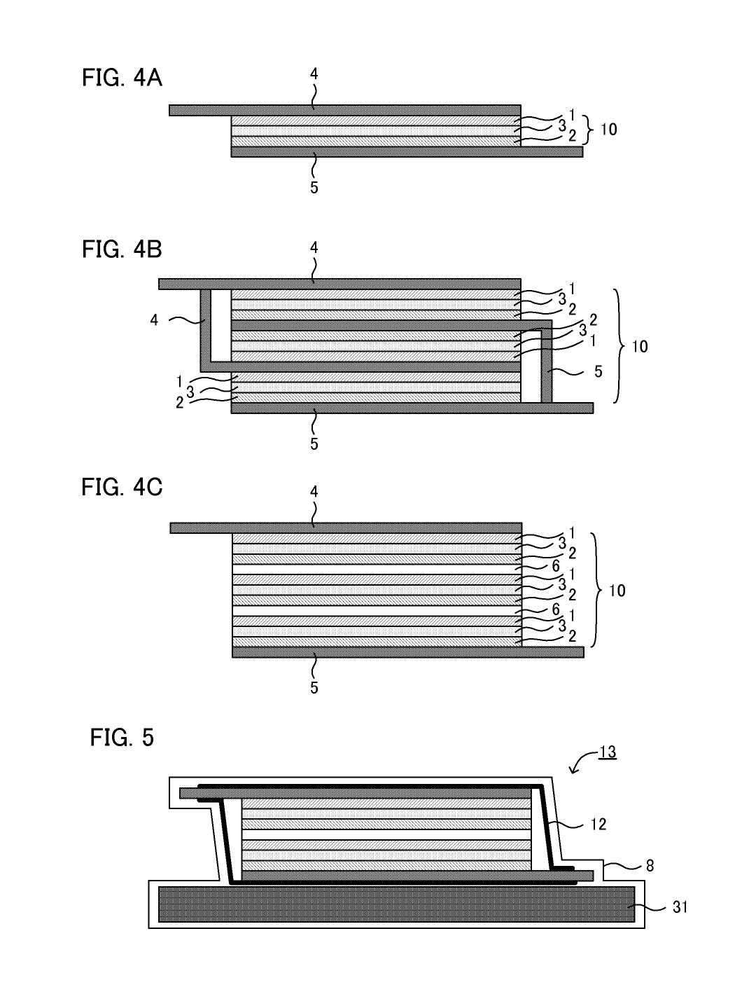

The battery element in the present invention may be a monopolar battery element or a bipolar battery element. FIGS. 4A to 4C are schematic cross-sectional views exemplifying the battery element in the present invention. FIG. 4A is a monopolar battery element, and this battery element comprises a power generating element 10 having a cathode active material layer 1, an anode active material layer 2 and a solid electrolyte layer 3 by one unit, a cathode current collector 4 for collecting the cathode active material layer 1, and an anode current collector 5 for collecting the anode active material layer 2.

FIG. 4B is a laminated monopolar battery element, and this battery element comprises a power generating element 10 having a cathode active material layer 1, an anode active material layer 2 and a solid electrolyte layer 3 by three units, a cathode current collector 4 for collecting the cathode active material layer 1, and an anode current collector 5 for collecting the anode active material layer 2. Also, in the laminated monopolar battery element, at least one of the cathode current collector and the anode current collector is disposed as an interlayer current collector. In the laminated monopolar battery element, the number of the laminations of the unit comprising the cathode active material layer 1, the anode active material layer 2 and the solid electrolyte layer 3 is not particularly limited but is, for example, preferably within a range of 2 to 60, and more preferably within a range of 2 to 20.

FIG. 4C is a bipolar battery element, and this battery element comprises a power generating element 10 having a cathode active material layer 1, an anode active material layer 2 and a solid electrolyte layer 3 by three units, an interlayer current collector 6 formed between each of the units, a cathode current collector 4 for collecting the cathode active material layer 1, and an anode current collector 5 for collecting the anode active material layer 2. In the bipolar battery element, the number of the laminations of the unit comprising the cathode active material layer 1, the anode active material layer 2 and the solid electrolyte layer 3 is not particularly limited but is, for example, preferably within a range of 2 to 60, and more preferably within a range of 2 to 20. Incidentally, a materiel for the interlayer current collector is not particularly limited, and the same as the materiel described in the above-mentioned cathode current collector and anode current collector may be used.

A method for producing the battery element in the present invention is not particularly limited but the same method as a general battery element may be used. Examples of the method for producing the battery element include a method such that slurry for forming the cathode active material layer is applied and dried on the cathode current collector to form the cathode active material layer, on which slurry for forming the solid electrolyte layer is applied and dried to form the solid electrolyte layer, on which slurry for forming the anode active material layer is applied and dried to form the anode active material layer, on which finally the anode current collector is disposed. Also, other examples of the method for producing the battery element include a method such that pellets of each of the cathode active material layer, the solid electrolyte layer and the anode active material layer are produced and held between the cathode current collector and the anode current collector.

(3) Battery Element-Containing Exterior Body

The battery element-containing exterior body in the present invention is such that the above-mentioned battery element is sealed with an exterior body. The exterior body is not particularly limited if the exterior body is such as to allow the battery element to be sealed, but examples thereof include a laminate sheet such that a metal substrate is coated with resin. Examples of a material for the above-mentioned metal substrate include aluminum. Also, examples of the above-mentioned resin include polyethylene terephthalate. Examples of a method for sealing the battery element with the exterior body include a method for disposing the battery element inside the exterior body to seal the exterior body by thermal weld under a reduced pressure.

(4) Body to be Pressed

As described above, specific examples of the body to be pressed include the power generating element, the battery element and the battery element-containing exterior body. Also, each of these members may be sealed with a protector for protecting from a pressing medium of isostatic pressing. For example, in the case where isostatic pressing is pressing by hydraulic pressure, the protector protects the body to be pressed from a liquid such as water. Also, the protector preferably has insulation properties. The reason therefor is to allow a short circuit of the power generating element to be prevented. Examples of a material for the protector include resin, rubber and metal (such as aluminum). The shape of the protector is not particularly limited and examples thereof include a filmy shape. Also, examples of a method for sealing with the protector include a method for sealing the protector by thermal fusion under a reduced pressure.

2. Pressing Method

Next, a pressing method in the present invention is described. A method for producing an all solid state battery of the present invention is greatly characterized in that a body to be pressed is isostatically pressed. Examples of isostatic pressing include pressing by hydraulic pressure and pressing by gas pressure. The pressing by hydraulic pressure has the advantage that as high a pressure as several hundred MPa is isostatically allowed to be applied, and the pressing by gas pressure has the advantage that pressure is isostatically allowed to be applied under the high temperature conditions. Typical examples of the pressing by hydraulic pressure include cold isostatic pressing (CIP). Also, in the pressing by hydraulic pressure, liquid becomes a pressing medium. Examples of the above-mentioned liquid include water. Also, the above-mentioned liquid may be in a normal temperature state or in a heating state.

On the other hand, typical examples of the pressing by gas pressure include hot isostatic pressing (HIP). Also, in the pressing by gas pressure, gas becomes a pressing medium. Examples of the above-mentioned gas include argon gas. Also, the above-mentioned gas may be in a normal temperature state or in a heating state. In the case of pressing by using the heated gas, the heating temperature of the gas is, for example, preferably 120° C. or less, and more preferably 80° C. or less.

The pressure of isostatic pressing is not particularly limited if the pressure is such as to allow desired adhesion properties to be obtained, but is, for example, preferably 200 MPa or more, and more preferably 300 MPa or more. The reason therefor is that too low pressure brings a possibility that adhesion properties between the electrode active material layers and the solid electrolyte layer may not sufficiently be improved. On the other hand, the above-mentioned pressure is, for example, preferably 1000 MPa or less, more preferably 800 MPa or less, and far more preferably 500 MPa or less. The reason therefor is that too high pressure brings a possibility that an internal short circuit is caused and equipment costs are increased. Also, the time of isostatic pressing varies with kinds of isostatic pressing, and is, for example, preferably within a range of 5 minutes to 60 minutes, and more preferably within a range of 10 minutes to 30 minutes.

Also, in the present invention, the body to be pressed preferably has an elastic body. The reason therefor is that the use of the elastic body allows the body to be pressed to be prevented from minutely deforming and a warp to be prevented from occurring. For example, as shown in FIG. 5, the exterior body-containing protector 13 as the body to be pressed preferably has an elastic body 31. Also, in FIG. 5, the battery element-containing exterior body 12 and the elastic body 31 are sealed with the protector 8 inside the exterior body-containing protector 13. Thus, on the occasion of isostatic pressing, a pressing medium (such as water) may be prevented from infiltrating into the exterior body-containing protector 13. The position where the elastic body is disposed is not particularly limited if the position is such as to allow a warp to be prevented from occurring, but the elastic body may be disposed so as to be included inside the body to be pressed, or disposed so as to be exposed outside the body to be pressed. Examples of a material for the elastic body include resin, rubber and metal (such as aluminum), and rubber is preferable above all. In addition, the elastic body is preferably hard while having elasticity in consideration of the elastic body itself which may result in the deformation. Thus, for example, the rubber is more preferably hard rubber. The thickness of the elastic body varies with the material for the elastic body, and is, for example, preferably within a range of 1 mm to 20 mm, and more preferably within a range of 3 mm to 10 mm.

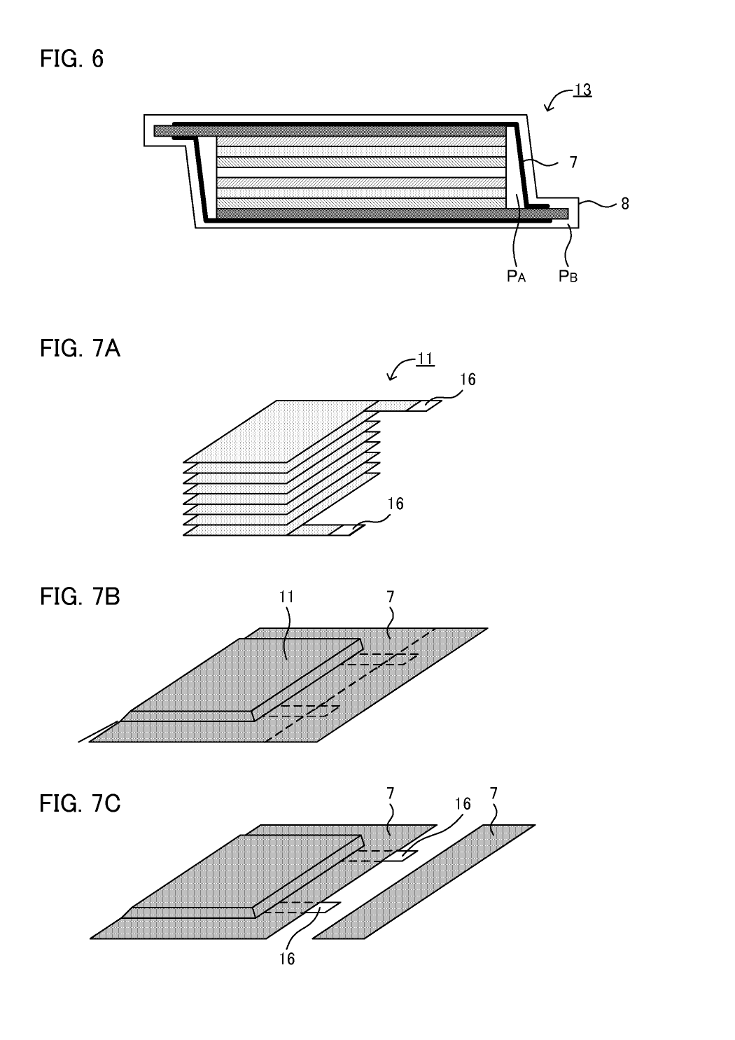

Also, in the present invention, it is preferable that the body to be pressed is such that the exterior body sealing the battery element is further sealed with a protector, and the pressure between the exterior body and the protector is made higher than the pressure inside the exterior body. The reason therefor is to allow a power generating element to be pressed more effectively. For example, as shown in FIG. 6, it is preferable that the body to be pressed is the exterior body-containing protector 13 such that the exterior body 7 sealing the battery element is further sealed with a protector 8, and the pressure P_{B} between the exterior body 7 and the protector 8 is higher than the pressure P_{A} inside the exterior body 7. P_{A} is, for example, preferably within a range of −100 kPa to −80 kPa, and more preferably within a range of −100 kPa to −90 kPa in gauge pressure (relative pressure). P_{B} is, for example, preferably within a range of −80 kPa to −60 kPa, more preferably within a range of −80 kPa to −70 kPa in gauge pressure (relative pressure). P_{B}—P_{A} is, for example, preferably 10 kPa or more, and more preferably within a range of 10 kPa to 20 kPa.

Also, in the present invention, it is preferable that the above-mentioned battery element is sealed with the exterior body so as to cover a terminal portion of the above-mentioned battery element, and part of the above-mentioned exterior body is cut off after the above-mentioned isostatic pressing to expose the above-mentioned terminal portion. The reason therefor is that the protection of the terminal portion by the exterior body allows the deformation due to isostatic pressing to be prevented. Also, the protection of the terminal portion by the exterior body allows the terminal portion to be prevented from contacting with water, and allows rust to be prevented from occurring. For example, as shown in FIGS. 7A and 7B, the battery element 11 is sealed with the exterior body 7 so as to cover a terminal portion 16 of the battery element 11. The isostatic pressing is performed in this state, and thereafter, as shown in FIG. 7C, part of the exterior body 7 is cut off to expose the terminal portion 16. Incidentally, the terminal portion 16 may be protected by a protecting tape (a release tape), or a notch may be previously processed in the exterior body 7.

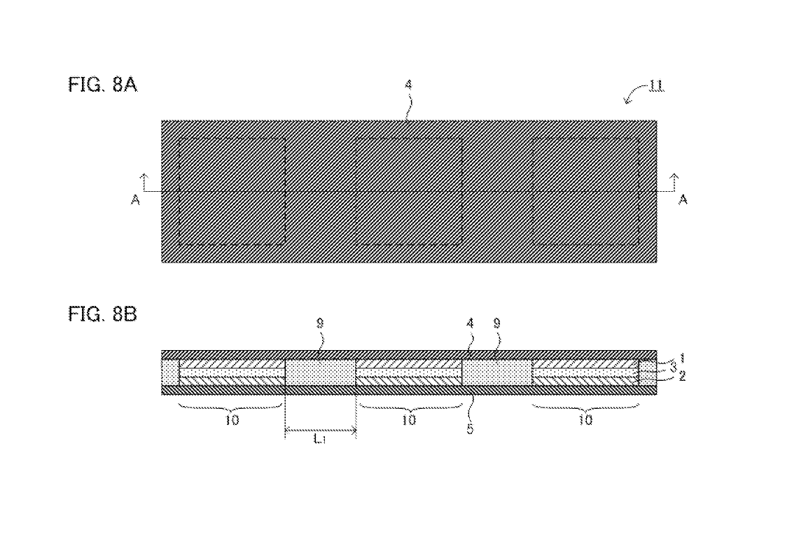

Also, in the present invention, it is preferable that the body to be pressed has the battery element having the power generating element, and the cathode current collector and the anode current collector for collecting the power generating element, and the battery element has a plurality of the power generating elements between the cathode current collector and the anode current collector, and has an insulating layer between the adjacent power generating elements. In addition, it is preferable that such a body to be pressed is bent in a position of the insulating layer to perform the isostatic pressing. The reason therefor is that the body to be pressed may be disposed with a high density in an isostatic pressing device by bending. Here, FIGS. 8A and 8B are schematic views showing an example of the battery element in the present invention. FIG. 8A is a schematic plan view of the battery element, and FIG. 8B is an A-A cross-sectional view of FIG. 8A. The battery element 11 shown in FIGS. 8A and 8B has a plurality of the power generating elements 10 between the cathode current collector 4 and the anode current collector 5 in parallel. The plurality of the power generating elements 10 is disposed so as to share the cathode current collector 4 and the anode current collector 5. Also, each of the power generating elements 10 is a monopolar power generating element in FIG. 8B, and may be the laminated monopolar power generating element 10 as shown in FIG. 4B or the bipolar power generating element 10 as shown in FIG. 4C. Also, an insulating layer 9 is formed between the adjacent power generating elements 10 and prevents the adjacent power generating elements 10 from short-circuiting. For example, an insulating tape and an insulating layer adhesive may be used for the insulating layer 9. Examples of the insulating layer adhesive include an acrylic adhesive, an ethylene-vinyl acetate adhesive and a silicone adhesive. Also, in the case where the length of the insulating layer 9 is regarded as L₁, the L₁ is preferably a length such as to be bendable; specifically, preferably within a range of 1 mm to 20 mm, and more preferably within a range of 3 mm to 15 mm.

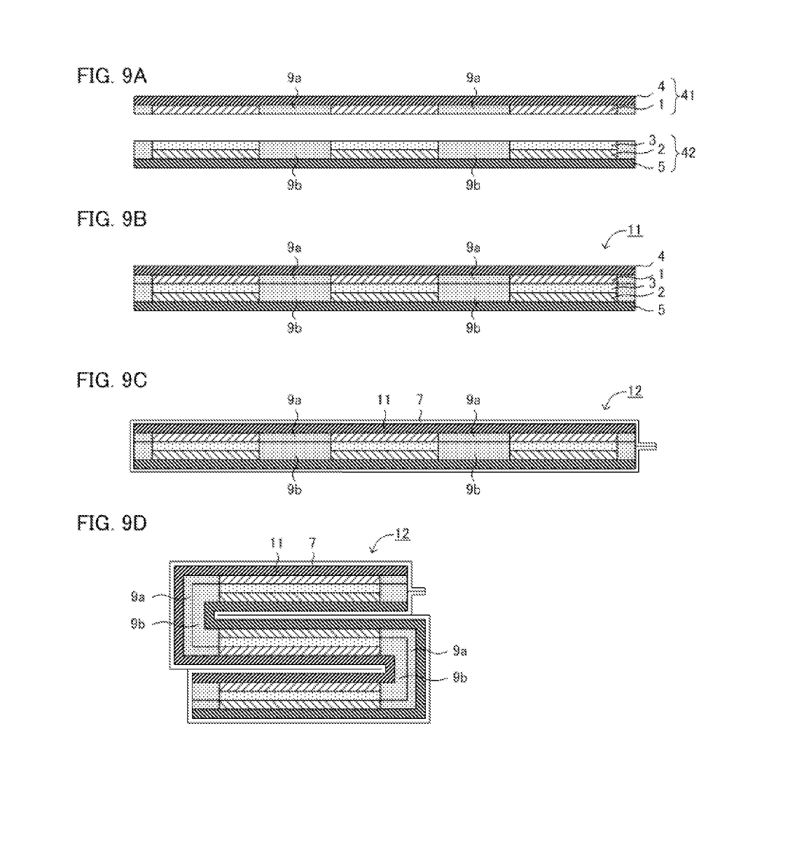

FIGS. 9A to 9D are schematic cross-sectional views showing an example of the method for producing an all solid state battery of the present invention. Specifically, the producing method by using the battery element shown in FIG. 8 is shown. In FIG. 9A, a first laminated body 41 having a plurality of the cathode active material layers 1, and an insulating layer 9a formed between the adjacent cathode active material layers 1 is prepared on the surface of the cathode current collector 4. Also, a second laminated body 42 having a plurality of laminate units comprising the anode active material layer 2 and the solid electrolyte layer 3, and an insulating layer 9b formed between the adjacent laminate units is prepared on the surface of the anode current collector 5. Next, as shown in FIG. 9B, the cathode active material layers 1 of the first laminated body 41 and the solid electrolyte layers 3 of the second laminated body 42 are closely stuck. Thus, the insulating layer 9a and the insulating layer 9b also stick closely together. For example, in the case where the insulating layer 9a and the insulating layer 9b comprise an insulating tape and do not stick closely together at the interface therebetween, an insulating adhesive may be applied on the interface between both. The battery element 11 is obtained in this manner.

Next, as shown in FIG. 9C, the battery element 11 is sealed with the exterior body 7 to obtain the battery element-containing exterior body 12. In this state, before performing the isostatic pressing, the battery element-containing exterior body 12 may be pressed by a general pressing method such as planar press and roll press. Next, as shown in FIG. 9D, the battery element-containing exterior body 12 is bent in a position of the insulating layers 9a and 9b. On this occasion, the bending is preferably performed so that the adjacent power generating elements 10 face each other. Incidentally, an isostatic pressing device has a cylindrical chamber, and rigidity of the chamber itself also needs to be simultaneously improved when the inside diameter of the chamber is increased. Therefore, the thickness of the chamber needs to be in proportion to the square or more of the inside diameter of the chamber, and the device is upsized. On the contrary, as shown in FIG. 9D, the bending of the body to be pressed allows the body to be pressed to be disposed with a high density in the isostatic pressing device, and allows the all solid state battery to be efficiently produced. Incidentally, in FIG. 9D, the insulating layers 9a and 9b are linearly bent; however, in order to avoid a sharp bending, the insulating layers 9a and 9b may be bent curvedly (such as to have an R shape).

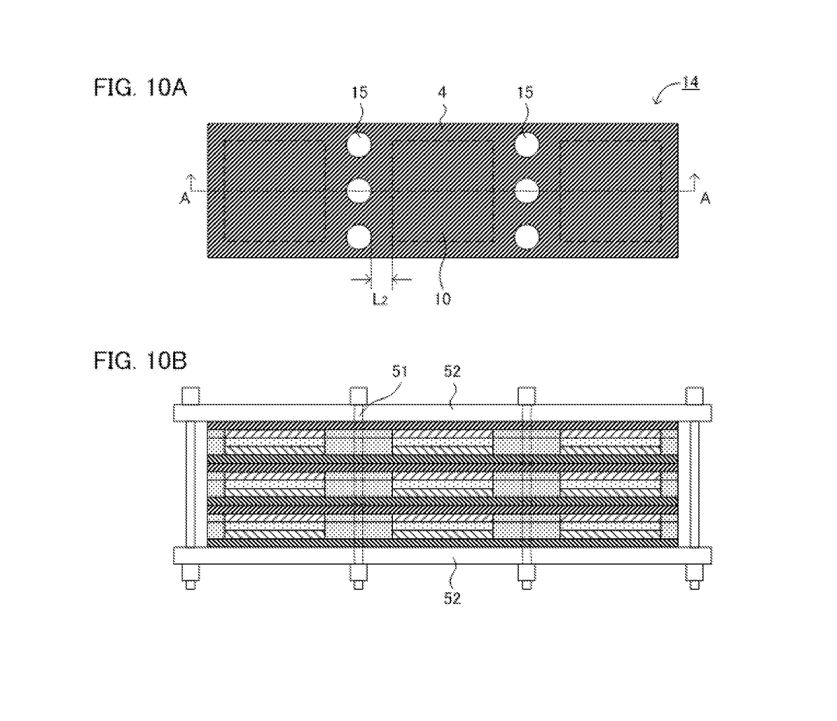

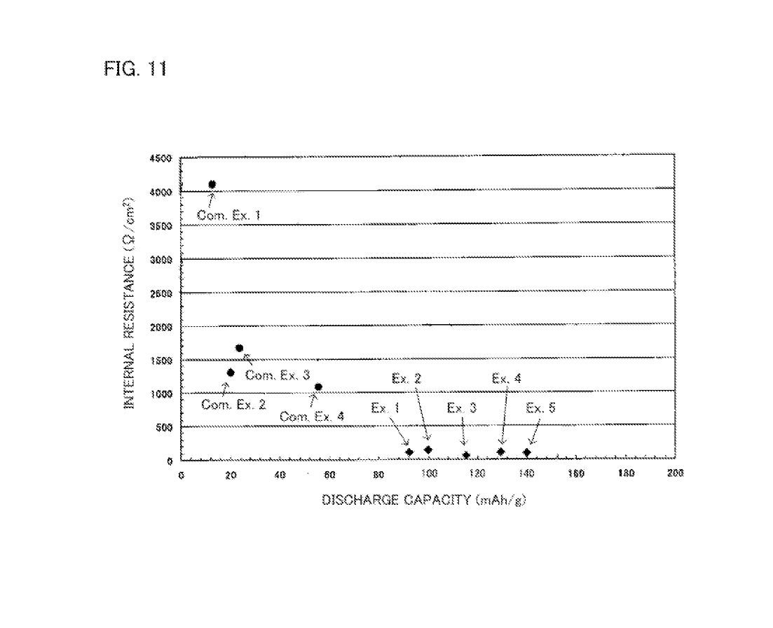

Also, after the isostatic pressing, the pressed member bent as shown in FIG. 9D may be directly used as the all solid state battery, and the bent part is extended to thereby obtain the plate-like pressed member, which may be used as the all solid state battery. Also, in the present invention, as shown in FIG. 10A, a through-hole 15 may be formed so as to pierce through the insulating layer of the plate-like pressed member 14. As shown in FIG. 10B, the formation of the through-hole 15 allows a jig 51 for fixing the battery such as a bolt and a wire to pass therethrough, and allows the all solid state battery to be fixed together with a keep plate 52. Examples of a method for forming the through-hole 15 include punching. Incidentally, the exterior body 7 shown in FIG. 9D is not shown in FIG. 10B; however, in the present invention, after the isostatic pressing, the all solid state battery may be fixed while removing the exterior body once, and the all solid state battery may be fixed without removing the exterior body.

Also, in the case of forming the above-mentioned through-hole, an insulating adhesive is preferably used for at least part of the insulating layer. The reason therefor is to allow the open air to be prevented from intruding into the battery through the through-hole. Examples of such an insulating layer include such that the insulating layer 9a (the insulating layer formed on the cathode active material layer side) and the insulating layer 9b (the insulating layer formed on the anode active material layer side) shown in FIG. 9B comprise an insulating tape to have an insulating adhesive on the interface between both. Also, other examples of the above-mentioned insulating layer include such that one of the insulating layer 9a (the insulating layer formed on the cathode active material layer side) and the insulating layer 9b (the insulating layer formed on the anode active material layer side) shown in FIG. 9B is an insulating tape and the other thereof is an insulating adhesive. In addition, the insulating layer may comprise only an insulating adhesive. Also, as shown in FIG. 10A, in the case where the length from the end of the through-hole 15 to the end of the power generating element 10 is regarded as L₂, the L₂ is preferably 2 mm or more, and more preferably within a range of 5 mm to 10 mm. The reason therefor is that too small L₂ brings a possibility that the open air reaches the power generating element, while too large L₂ brings a possibility that energy density of the battery deteriorates.

3. All Solid State Battery

Examples of kinds of the all solid state battery obtained by the present invention include an all solid lithium battery, an all solid sodium battery, an all solid magnesium battery and an all solid calcium battery; above all, an all solid lithium battery is preferable. Also, the all solid state battery obtained by the present invention may be a primary battery or a secondary battery, and preferably a secondary battery. The reason therefor is to be useful as a car-mounted battery, for example.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples and comparative examples hereinafter.

### Example 1

Slurry containing LiNi_{1/3}Co_{1/3}Mn_{1/3}O₂ (a cathode active material) and 75Li₂S.25P₂S₅ glass (a sulfide solid electrolyte material) at a weight ratio of 6:4 was coated on an aluminum foil (a cathode current collector) to obtain a cathode. Next, slurry containing graphite (an anode active material) and 75Li₂S.25P₂S₅ glass (a sulfide solid electrolyte material) at a weight ratio of 6:4 was coated on a copper foil (an anode current collector) to obtain an anode. Next, slurry containing 75Li₂S.25P₂S₅ glass (a sulfide solid electrolyte material) was coated on an anode active material layer of the obtained anode to form a solid electrolyte layer. Next, the anode and the cathode were laminated so that the solid electrolyte layer formed on the anode and a cathode active material layer of the cathode contact, and punching was performed to obtain a battery element (φ16 cm²). The obtained battery element was covered with a water-resistant film and disposed in a CIP device filled with water. In this state, isostatic pressing was performed on the conditions of 200 MPa, 25° C. and 5 minutes. Thus, an all solid secondary battery was obtained.

### Examples 2 to 5

An all solid secondary battery was obtained in the same manner as Example 1 except for modifying the conditions of isostatic pressing as shown in the following Table 1.

TABLE 1

| | | TEMPERATURE |
|---|---|---|
| | PRESSURE (MPa) | (° C.) |
| EXAMPLE 2 | 400 | 25 |
| EXAMPLE 3 | 980 | 120 |
| EXAMPLE 4 | 400 | 80 |
| EXAMPLE 5 | 980 | 80 |

### Comparative Examples 1 to 4

The battery element obtained in Example 1 was pressed (25° C.) by roll press to obtain an all solid secondary battery. The conditions of roll press were determined as shown in the following Table 2. Incidentally, linear pressure was adjusted by a gap between upper and lower rollers.

TABLE 2

| | LINEAR PRESSURE (MPa) |
|---|---|
| COMPARATIVE EXAMPLE 1 | 50 |
| COMPARATIVE EXAMPLE 2 | 100 |
| COMPARATIVE EXAMPLE 3 | 100 |
| COMPARATIVE EXAMPLE 4 | 150 |

### [Evaluations]

(Discharge Capacity Measurement)

The all solid secondary battery obtained in Examples 1 to 5 and Comparative Examples 1 to 4 was charged with constant voltage and constant current up to 4.55 V at a current value of 0.1 C, and thereafter discharged with constant current up to 2.5 V to thereby measure discharge capacity per 1 g of an active material. The results are shown in FIG. 11.

(Internal Resistance Measurement)

After measuring discharge capacity, the all solid secondary battery was charged up to 3.6 V to adjust the voltage, perform impedance analysis by an impedance analyzer (manufactured by SolartronInc.), and then measure internal resistance. The results are shown in FIG. 11.

(Results)

As shown in FIG. 11, it was confirmed that the all solid secondary battery obtained in Examples 1 to 5 was high in discharge capacity and low in internal resistance as compared with the all solid secondary battery obtained in Comparative Examples 1 to 4.

### REFERENCE SIGNS LIST

1 Cathode active material layer
2 Anode active material layer
3 Solid electrolyte layer
4 Cathode current collector
5 Anode current collector
6 Interlayer current collector
7 Exterior body
8 Protector
9 Insulating layer
10 Power generating element
11 Battery element
12 Battery element-containing exterior body
13 Exterior body-containing protector
14 Pressed member
15 Through-hole
16 Terminal portion
21 Liquid
22 Pressure-resistant container
23 Pressure
31 Elastic body

1-7. (canceled)

8. A method for producing an all solid state battery comprising a pressing step of isostatically pressing a body to be pressed, provided with a power generating element having a cathode active material layer, an anode active material layer, and a solid electrolyte layer formed between the cathode active material layer and the anode active material layer;
wherein a pressure of the isostatic pressing is within a range of 300 MPa to 1000 MPa.

9. The method for producing an all solid state battery according to claim 8, wherein the isostatic pressing is pressing by hydraulic pressure.

10. The method for producing an all solid state battery according to claim 8, wherein the body to be pressed is such that a battery element having the power generating element, and a cathode current collector and an anode current collector for collecting the power generating element is sealed with an exterior body.

11. The method for producing an all solid state battery according to claim 8, wherein the body to be pressed has an elastic body.

12. The method for producing an all solid state battery according to claim 10, wherein
the body to be pressed is such that the exterior body sealing the battery element is further sealed with a protector; and
a pressure between the exterior body and the protector is made higher than a pressure inside the exterior body.

13. The method for producing an all solid state battery according to claim 11, wherein
the body to be pressed is such that an exterior body sealing a battery element is further sealed with a protector; and
a pressure between the exterior body and the protector is made higher than a pressure inside the exterior body.

14. The method for producing an all solid state battery according to claim 8, wherein
the body to be pressed has a battery element having the power generating element, and a cathode current collector and an anode current collector for collecting the power generating element;
the battery element has a plurality of the power generating elements between the cathode current collector and the anode current collector, and has an insulating layer between the adjacent power generating elements; and
the body to be pressed is bent in a position of the insulating layer.
